(19) United States
(12) Patent Application Publication
(10) Pub. No.: US 2023/0172178 A1
(43) Pub. Date: Jun. 8, 2023

(54) FISHING SINKER

(71) Applicant: TOKAI ION CO., LTD., Aichi (JP)

(72) Inventor: Mitsutaka MATSUMURA, Aichi (JP)

(21) Appl. No.: 17/921,153

(22) PCT Filed: Apr. 23, 2021
(86) PCT No.: PCT/JP2021/016519

§ 371 Date: Oct. 25, 2022

(30) Foreign Application Priority Data
Apr. 27, 2020 (JP) 2020-078443

(51) Int. Cl. A01K 85/01; A01K 95/00; A01K 85/00

(52) U.S. Cl. CPC A01K 85/018; A01K 95/005; A01K 85/1837

(57) ABSTRACT

The present disclosure provides a fishing sinker including a main body that is a casting, and a nitrided layer formed by nitriding a surface of the main body, and communication pores are provided in the nitrided layer and the main body with the communication pores configured to be impregnated with a liquid fishing bait for attracting fish. With communication pores impregnated with a liquid fishing bait for attracting fish, the liquid fishing bait is securely held in the nitrided layer.

### TECHNICAL FIELD

The present invention relates to a fishing sinker having a fish-attracting effect.

### BACKGROUND ART

In fishing with artificial baits such as lures, liquid fishing bait containing shrimp or other fish-attracting ingredients is sometimes applied to or infiltrated into the artificial baits in order to attract fish by attaching the smell of the baits.

However, the liquid fishing bait flows out into the water each time a fishing tackle is cast into the water, diminishing the fish-attracting effect, so the liquid fishing bait must be reapplied approximately every four castings, thus using such artificial bait is complicated.

On the other hand, Patent Document 1 introduces the invention of a soft lure for fishing, characterized in that the soft lure molded from soft resin or other materials is provided with a large number of small pores for storing liquid fishing bait. This invention allows liquid fishing bait to be continuously stored in the numerous pores on the surface of the soft lure, thus maintaining its fish-attracting effect.

Further, Patent Document 2 introduces the invention of a cover for a sinker with a protrusion or recess on the inside of the membrane of a cover for a sinker that is removably covered with a fishing sinker, forming a space that can accommodate liquid fishing bait. This invention allows liquid fishing bait to gradually seep out of the water between the sinker and the cover, thus maintaining its fish-attracting effect. Furthermore, Patent Document 3 also introduces a fishing sinker, in which odor component of bait such as cockle and shrimp are impregnated or applied to a sintered metal body sintered so that apertures and communication pores are formed between metal powder particles, or to a metal body with apertures and communication pores.

However, even with these methods, the duration of the liquid fishing bait is still short, hence requiring frequent reapplication of the liquid bait. In addition, it is difficult to make a sinker that can be universally attached to today's diversified fishing tackles.

In fishing, sinker is usually used to send a trap, including a hook, to the desired location to sink bait. Conventionally, lead, which does not rust, has been widely used for fishing sinkers. Recently, water pollution of rivers and oceans caused by heavy metals such as lead has become a problem. In order to prevent such water pollution, it has recently become desirable to use tungsten as a material. (as introduced in Non-Patent Document 1) For example, Patent Documents 4 and 5 introduce fishing sinkers made of tungsten. However, tungsten is expensive that it is difficult to prevent water pollution by widely spreading tungsten sinkers.

### CITATION LIST

### Patent Literature

Patent Document 1: Japanese Unexamined Patent Publication No. 2014-100134

Patent Document 2: Japanese Utility Model Registration No. 3225397

Patent Document 3: Japanese Unexamined Utility Model Publication No S64-3572

Patent Document 4: Japanese Unexamined Patent Publication No. 2003-144025

Patent Document 5: Japanese Unexamined Patent Publication No. 2015-080417

### Non-Patent Literature

Non-Patent Document 1: [retrieved on Mar. 30, 2020], Internet <URL: http://bassyan.com /b-tungsten.html>

### SUMMARY OF THE INVENTION

### Problem to be Solved by the Invention

Therefore, the purpose of this invention is to provide a fishing sinker that enables to maintain a fish-attracting effect even after repeatedly cast into water regardless of the type of fishing tackle, and also enables to inexpensively prevent water pollution of rivers and the ocean by metals.

### Means to Solve the Problem

The present invention is a fishing sinker for use in fishing, characterized by comprising: a main body that is a casting; and a nitrided layer formed by nitriding a surface of the main body, wherein communication pores are provided in the nitrided layer and the main body, the communication pores being configured to be impregnated with a liquid fishing bait for attracting fish.

Further, the nitrided layer may be provided with a homo-treated layer formed by performing a homo-treatment on a surface, and the aforementioned communication pores may also be connected to the homo-treated layer.

Furthermore, the present invention of another embodiment is a fishing sinker for use in fishing, characterized by comprising: a main body that is a casting and a homo-treated layer formed by performing a homo-treatment on a surface of the main body, wherein communication pores are provided in the homo-treated layer and the main body, the continuous pores being configured to be impregnated with a liquid fishing bait for attracting fish.

### Advantageous Effects of the Invention

The fishing sinker according to the present invention has the effect of being universally attachable to a variety of tackles by using the fishing sinker, which is an indispensable an indispensable component in fishing tackles, with a liquid fishing bait.

In addition, communication pores are impregnated with fish-attracting liquid bait by providing communication pores on the nitrided layer, the homo-treated layer, and the main body, thus fish-attracting liquid bait leach out very slowly and remain in the water for a longer period of time. Therefore, sustain the fish-collecting effect for a longer period of time even when the bait is repeatedly put into the water.

Furthermore, it has the effect of preventing water pollution by metals in rivers and the sea at a low cost due to adopt the casting, which is less expensive than tungsten, and provide a nitrided and homo-treated layer on the surface of the casting to give it rust-preventive properties.

### BRIEF DESCRIPTION OF THE DRAWINGS

FIG. 1A is a schematic view of a fishing sinker illustrating an embodiment of the present invention, and FIG. 1B is an illustration depicting a usage state of the fishing sinker of the present invention.

FIG. 2 illustrates a schematic cross-sectional view of the body of the fishing sinker depicted in FIG. 1.

FIG. 3 illustrates a schematic cross-sectional view of the nitrided layer formed on the surface of the main body of the fishing sinker depicted in FIG. 2.

FIG. 4 illustrates a schematic view of impregnating a fishing sinker with liquid fishing bait.

FIG. 5 illustrates a schematic cross-sectional view of the formation of the homo-treated layer on the surface of the nitrided layer of the fishing sinker in FIG. 3.

FIG. 6 illustrates a schematic cross-sectional view of the formation of the homo-treated layer on the surface of the body of the fishing sinker in FIG. 2.

### DETAILED DESCRIPTION OF EMBODIMENTS

A fishing sinker that embodies the present invention will be described hereinafter with reference to the attached drawings.

### Example 1

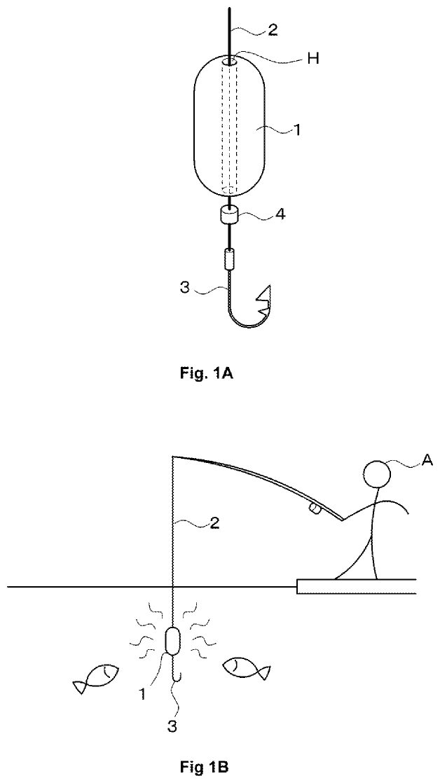

FIG. 1 is an illustration depicting a usage state of the fishing sinker of the present invention. The fishing sinker 1 depicted in FIG. 1A is called a interline sinker having an abbreviated cocoon shape and an insertion hole H for inserting a fishline 2. The fishing tackle is completed by inserting a fishline 2 through the insertion hole H, attaching a hook 3 to the end of the line 2, and attaching a clamp 4 that defines the position of the fishing sinker 1. FIG. 1B illustrates a scene of fishing with a fishing tackle. Fishing tackle differs depending on the fishing environment such as species of the target and location. Thus, fishing sinkers have various shapes and types; split sinkers, split shots, interline sinkers, sinker plates, eggplant-shaped sinkers, balances, barrette sinkers, and so forth. The fishing sinker 1 according to the present invention can be employed regardless of the type and shape of these sinkers.

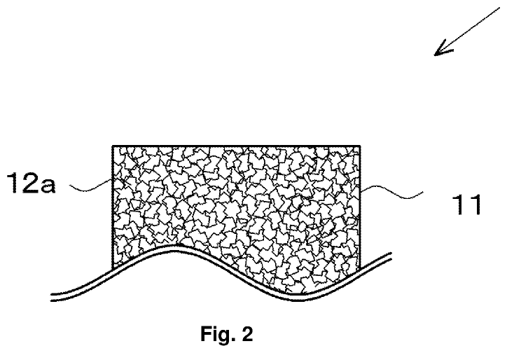

As depicted in FIG. 2, the main body of the fishing sinker 1 is made of cast metal made by casting, i.e., a metal product formed by pouring molten metal into a mold and then cooling and hardening it. Casting is a technique used since ancient times, and naturally occurring metal materials such as gold, silver, copper, iron, aluminum, zinc, and magnesium can be used universally as materials for cast products. Casting has an advantage over other metalworking methods in that they are less time-consuming to produce. Any metal material can be adopted as the material of the fishing sinker 1 according to the present invention, it is preferable to use cast iron, an alloy composed mainly of iron, carbon, and silicon from the viewpoints of economy, versatility, and strength.

The casting 11, which is the main body of the fishing sinker 1, has many microscopic pores 12a, called cavities, from the surface to the inside. These pores are caused by volume contraction and gas emission as the metal transforms from a liquid to a solid. The size of each pore 12a is approximately 5 μm to 100 μm in diameter. The pores 12a are connected from the surface of the casting 11 to the inside of it. The plurality of communication pores 12a form a communication pore 12 from the surface of the casting 11 to the inside of the casting 11. When a fishing sinker made of casting as described above, especially cast iron, is immersed in river or sea water without any treatment, water seep into the inside of the body of the fishing sinker 1 through the holes 12a. This is what causes rust.

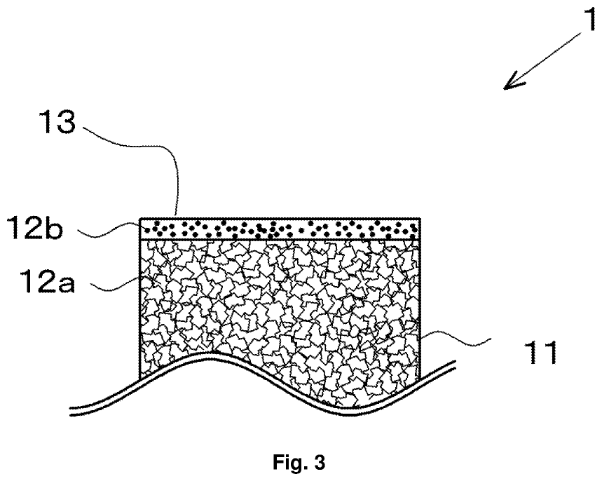

As depicted in FIG. 3, the fishing sinker 1 has a nitrided layer 13, which is formed by nitriding the surface of the casting 11. Nitriding is one of the chemical surface hardening methods that harden the surface of metals through heat treatment and chemical reaction. This method is a metalworking process to harden the surface of metals such as steel and titanium alloys by exposing them to a nitriding atmosphere at high temperatures and allowing nitrogen to permeate and diffuse within the metal, causing a chemical reaction that forms a layer of nitride compounds. Nitriding is a low-temperature treatment in which the heating temperature of the metal itself is around 500° C., therefore it is possible to improve the corrosion resistance, abrasion resistance, fatigue resistance, and heat resistance of the metal while reducing the deformation. Another advantage is that because it is a nitrogen-based processing method, it has little impact on the environment and safety. More specifically, nitriding has various treatment methods, including gas nitriding, gas soft-nitriding, special sulfonitriding called MIC treatment, salt bath soft-nitriding called tufftriding, plasma nitriding/ion nitriding, radical nitriding, and so forth. As the most preferable nitriding treatment for the fishing sinker 1 of the present invention, gas nitriding or gas nitrocarburizing can be adopted.

The thickness of the nitrided layer 13 in this example can be formed from 10 μm to 300 μm from the surface of the fishing sinker 1, and 30 μm is more preferred.

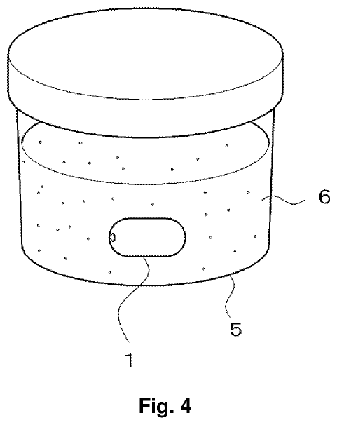

The nitrided layer 13 is formed with many pores 12b, each with a diameter of about 0.6 μm to 2 μm, which are even smaller than the pores 12a.The pores 12b are connected from the surface of the nitrided layer 13 to the back side which is the side facing the casting 11. The plurality of interconnected pores 12b passing from the surface of the nitrided layer 13 to the back surface connect to the plurality of pores 12a which are connected from the surface of the casting 11 to the inside of the casting 11. The communication pores 12 are formed with these pores 12a/b. Therefore, as depicted in FIG. 4, by submerging the fishing sinker 1 in the liquid fishing bait 6 filled in container 5 for a certain period of time (1 to 10 hours), the nitrided layer 13 and casting 11 are firmly impregnated with the fish-attracting liquid fishing bait through the communication pores 12. For liquid bait 6, any type of liquid can be applied as long as it is able to impregnate in the communication pores 12 and have some fish-attracting effects such as stimulating the fish's sense of smell and attracting them. It is especially preferable to use something with a high viscosity, such as oil, that is suitable for holding in the communication pores 12 for a long period of time. It is also possible to select the type of liquid fishing bait 6 to be used according to the purpose of fishing and targets.

According to the fishing sinker 1 equipped with the above configuration, when the fishing tackle is thrown into the water of a river/ocean and so forth, the odor of the liquid fishing bait 6 is emitted from the fishing sinker 1, and fish are attracted by the odor and gather around it. Then gathered fish bite the lure or hook 3 attached around the fishing sinker 1, which allows the fish to be caught. In view of the above, the communication pores 12 are formed so that they become narrower as from the inside of the fishing sinker 1 as toward the surface because each of the pores 12b is smaller than pores 12a. Thus, the release rate of the liquid fishing bait 6 can be reduced to a slow rate.

In addition, the fishing sinker 1 has a nitrided layer 13 with rust and corrosion resistance on the surface of the casting 11, so that the inexpensive casting 11 with rust and corrosion resistance, making it economical and preventing water pollution.

### Example 2

Next, the fishing sinker 1 of Example 2 will be described. Since the casting 11 and nitrided layer 13 have the same configuration of the Example 1, the description of these will be omitted.

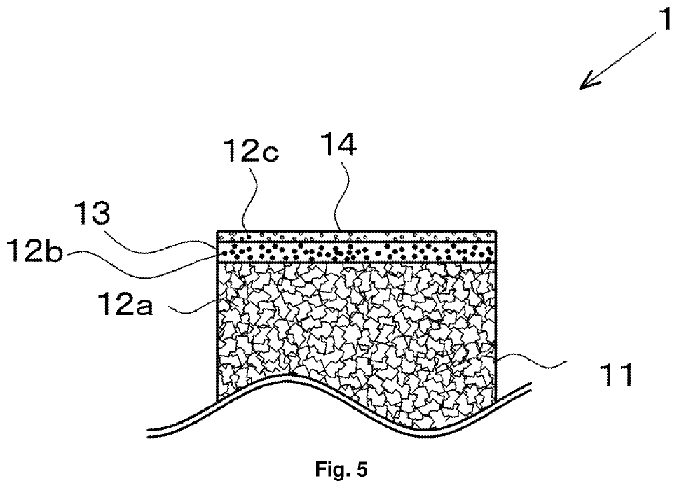

As depicted in FIG. 5, the fishing sinker 1 in Example 2 is equipped with a homo-treated layer 14, which is homo-treated on the surface of the nitrided layer 13. Homo treatment is a type of surface heat treatment process for metals, in which the target metal is preheated at 350-370° C. and then heated to around 500° C. for 30 to 60 minutes with steam to form a black rust coating layer on the metal surface. The homo treatment creates a porous layer with good adhesion on the metal surface, which improves corrosion and wear resistance when immersed in oil.

The homo-treated layer 14 in this example is formed at a thickness of 2 μm to 6 μm from the surface of the fishing sinker 1. It is preferable to form it to a thickness of about 3 μm.

Homo-treated layer 14 is formed with many pores 12c, each with a diameter of about 0.5 μm, which are even smaller than the pores 12b. The pores 12c are connected from the surface of the homo-treated layer 14 to the back side which is the side facing the nitrided layer 13. The plurality of interconnected pores 12c passing from the surface of the homo-treated layer 14 to the back surface connect to the plurality of pores 12b which are connected from the surface of the nitrided layer 13 to the inside of the nitrided layer 13 and connect to the plurality of pores 12a which are connected from the surface of the casting 11 to the inside of the casting 11. The communication pores 12 are formed with these pores 12a, 12b, and 12c. Therefore, by submerging the fishing sinker 1 in the liquid fishing bait 6 filled in container 5, the homo-treated layer 14, the nitrided layer 13, and the casting 11 are firmly impregnated with the fish-attracting liquid fishing bait through the communication pores 12.

In view of the above, the communication pores 12 are formed so that they become narrower as from the inside of the fishing sinker 1 as toward the surface because the pores 12c is smaller than the pores 12b and the pores 12b is smaller than the pores 12a. Thus, the release rate of the liquid fishing bait 6 filled in the communication pores 12 to be fed into the water of rivers/oceans, and so forth released at a much slower rate than the fishing sinker 1 formed with only nitride layer 13.

Furthermore, by layering the nitrided layer 13 and the homo-treated layer 14 on the surface of the fishing sinker 1, the characteristics of each metal surface treatment can be combined. The nitrided layer 13 and the homo treatment layer 14 can be combined on the surface of the fishing sinker 1. In addition, corrosion resistance and wear resistance can be improved compared to those of the individual treatments. Thus, it is possible to add further rust preventability, corrosion resistance, and abrasion resistance, and to provide a fishing sinker 1 that is economical and prevents water pollution at a low cost.

### Example 3

Next, the fishing sinker 1 of the Example 3 will be described. Since the casting 11 has the same configuration, the description thereof will be omitted.

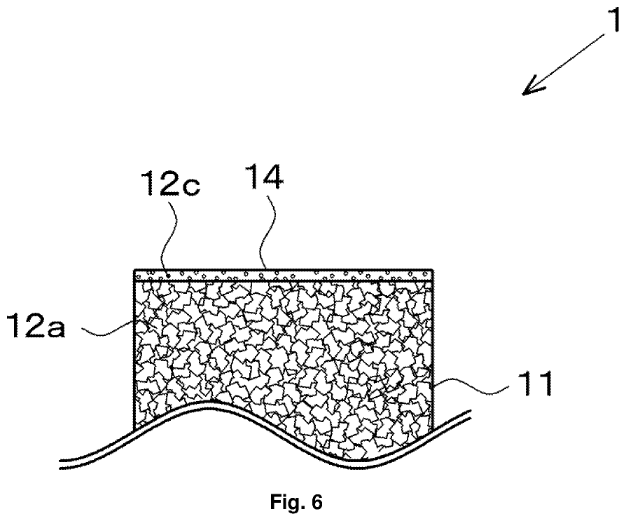

As depicted in FIG. 6, the fishing Sinker 1 of the Example 3 forms the homo-treated layer 14 by subjecting the surface of the cast object 11 to the homo-treated. The homo-treated layer 14 in this example is formed to have a thickness of about 2 μm to 6 μm from the surface of the fishing Sinker 1 It is preferably formed to a thickness of about 3 μm.

Homo-treated layer 14 is formed with many pores 12c, each with a diameter of about 0.5 μm, which are even smaller than the pores 12a. The pores 12c are connected from the surface of the homo-treated layer 14 to the back side which is the side facing the casting 11. The plurality of interconnected pores 12c passing from the surface of the homo-treated layer 14 to the back surface connect to the plurality of pores 12a which are connected from the surface of the casting 11 to the inside of the casting 11. The communication pores 12 are formed with these pores 12a/c. Therefore, by submerging the fishing sinker 1 in the liquid fishing bait 6 filled in container 5, the connecting pores 12 are firmly impregnated with the fish-attracting liquid fishing bait.

In view of the above, the communication pores 12 are formed so that they become narrower as from the inside of the fishing sinker 1 as toward the surface because each of the pores 12c is smaller than pores 12a. Thus, the release rate of the liquid fishing bait 6 filled in the communication pores 12 to be fed into the water of rivers/oceans, and so forth released at a slower rate.

Furthermore, by forming a homo-treated layer 14 on the surface of the fishing sinker 1, it is possible to provide rustproofing, corrosion resistance, and abrasion resistance, so that fishing sinker 1 which is economical and prevents environmental pollution using the cacting 11 can be provided.

The present invention is not limited to the above embodiments. For instance, the configuration of each part can be changed as appropriate to the extent not to depart from the purpose of the invention, as follows.
(1) To apply shot blasting treatment to the surface of the nitrided layer 13. This can improve the strength of the fishing sinker 1.
(2) To apply homo treatment to the surface of the nitrided layer 13 that has undergone the shot blasting treatment described in (1) to form a homo-treated layer 14. This allows the fishing sinker 1, whose strength has been improved by the shot-blast treatment, to further have the advantageous characteristics of the homo-treated layer 14.

### LIST OF REFERENCE NUMERALS

1 Fishing sinker
2 Fishline
3 Fishing hook
4 Fastener
5 Container
6 Liquid fishing bait
11 Casting
12 Communication pores
12a, 12b, 12c Pores
13 Nitrided layer
14 Homo-treated layer
H Insertion hole
A Angler

What is claimed is:

1. A fishing sinker for use in fishing, comprising:
a main body that is a casting; and
a nitrided layer formed by nitriding a surface of the main body,
wherein communication pores are provided in the nitrided layer and the main body, the communication pores being configured to be impregnated with a liquid fishing bait for attracting fish.

2. The fishing sinker of claim 1 further comprising a homo-treated layer formed by performing a homo-treatment on a surface of the nitrided layer,
wherein the communication pores are provided also in communication with the homo-treated layer.

3. A fishing sinker for use in fishing, comprising:
a main body that is a casting; and
a homo-treated layer formed by performing a homo-treatment on a surface of the main body,
wherein communication pores are provided in the homo-treated layer and the main body, the continuous pores being configured to be impregnated with a liquid fishing bait for attracting fish.
